(19) United States
(12) Patent Application Publication
(10) Pub. No.: US 2007/0298278 A1
(43) Pub. Date: Dec. 27, 2007

(54) SURFACE-POLISHABLE IRIDIUM OXIDE COMPOSITE HYDROGEN ION ELECTRODE AND METHOD OF MANUFACTURING THE SAME

(75) Inventors: Jong Man PARK, Gyeonggido (KR); Ji Young KIM, Songpa-gu (KR)

Correspondence Address: ADAM K. SACHAROFF;MUCH SHELIST FREED DENENBERG AMENT&RUBENSTEIN,PC, 191 N. WACKER DRIVE, SUITE 1800, CHICAGO, IL, 60606-1615, US

(73) Assignee: KONKUK UNIVERSITY INDUSTRIAL COOPERATION CORP., Seoul (KR)

(21) Appl. No.: 11/764,906

(22) Filed: Jun. 19, 2007

(30) Foreign Application Priority Data
Jun. 23, 2006 (KR) 10-2006-0056722

(51) Int. Cl. B32B 18/00; B29B 9/12; B29B 9/16

(52) U.S. Cl. 428/640; 264/6

(57) ABSTRACT

Disclosed herein is a surface-polishable iridium oxide composite hydrogen ion electrode and a method of manufacturing the same, and, more particularly, a surface-polishable iridium oxide composite hydrogen ion electrode, which has a long life due to its excellent physical strength, pH dependency approximate to a theoretical value (59 mV/pH unit), and high surface renewability, and a method of manufacturing the same. The iridium oxide composite hydrogen ion electrode according to the present invention is effective in that, when the electrode is contaminated or inactivated, the surface of the electrode can be regenerated through a simple polishing process because the electrode has high surface renewability, unlike conventional electrodes. The iridium oxide composite electrode according to the present invention can be usefully used in a water-quality monitoring system for monitoring the hydrogen ion concentration of a solution for a long period, an online pH measurement system, and pH measurement for samples, which causes serious contamination of the surface of a sensor.

### BACKGROUND OF THE INVENTION

1. Field of the Invention

The present invention relates to a surface-polishable iridium oxide composite hydrogen ion electrode and a method of manufacturing the same, and, more particularly, to a surface-polishable iridium oxide composite hydrogen ion electrode, which has a long life due to its excellent physical strength, pH dependency approximate to a theoretical value (59 mV/pH unit), and high surface renewability, and to a method of manufacturing the same.

2. Description of the Related Art

Generally, pH is one of basic analysis items measured in various fields, such as environmental, food, and medical fields. In particular, in the case where sensors are exposed to the possibility of being contaminated by environmental samples for a long period, as in a long-term water-quality monitoring system, or in the case where pH is measured in a state in which the properties of the sample cause serious contamination of the surface of the sensor, like samples used in soil analysis processes, food production processes and the like, pH glass membrane sensors have conventionally been used, but there is a problem in that the sensors must be periodically changed or reactivated because the sensors become inactivated due to the long-period exposure of the sensors to environmental samples, thus becoming seriously fouled. However, it is hardly to find there is no effective method for overcoming the inactivation and fouling problems.

pH selective glass membrane electrodes, which are commonly-used pH sensors, have problems in that they are fragile and cannot be easily reactivated whenever contaminated or fouled. Further, polymer membrane ion selective electrodes or coated-wire type selective electrodes, based on an ion carries, are advantageous in that they are easily manufactured and can be manufactured at a small size, but are disadvantageous in that, since they are formed of a physically weak and thin polymer film, they have low durability and it is impossible to reactivate and regenerate the surface thereof.

Meanwhile, it was reported in the document (A. Fog, R. P. Buck, Sensors and Actuators, 1984, 5, 137-146) that metal oxide films formed on the surface of precious metal electrodes can be used for measuring hydrogen ion concentration because the potentials due to the oxidation-reduction reaction of the metal oxides depend on the hydrogen ion concentration, and these metal oxides include TiO₂, RuO₂, RhO₂, SnO₂, Ta₂O₅, OsO₂, PdO₂, PtO₂, IrO₂, and the like. The hydrogen ion selective electrodes using metal oxides are mostly based on the fact that the potentials due to the reversible oxidation-reduction reaction of most of the metal oxides depend on the hydrogen ion concentration. These metal oxide film pH electrodes are manufactured using a sputtering method, a pyrolysis method, or an electrochemical oxidation method using metal wires. As the result of basic electrochemical research, it was found that, among these metal oxides, iridium oxide (IrO₂) exhibits the most excellent hydrogen ion selectivity and sensitivity.

A typical electrochemical oxidation method is a method of dipping iridium (Ir) electrodes in a sulfuric acid solution and oxidizing iridium of the electrodes to iridium oxides by cycling the potential of the electrode in the range of −0.25 to +1.25 V (vs. SCE). The iridium oxides formed on the metal electrodes are hydrated iridium oxides, such as IrO₂.4H₂O, Ir(OH)₄.2H₂O, [IrO₂(OH₂.2H₂O]²⁻, or the like. It is disclosed in the document (D. Midgly, Talanta, 1990, 37, 767-781) that the iridium oxides exhibit a super-Nerntian response of about 90 mV/pH unit according to Equation 1 below.

2[IrO₂(OH)₂.2H₂O]²⁻+3H⁺+2e⁻ [symbol] [Ir₂O₃(OH)₃.3H₂O]³⁻+3H₂O [Equation 1]

Further, in the case of iridium oxide film electrodes formed on the surface of platinum or iridium electrodes using a sputtering method or a pyrolysis method. The iridium oxides selectivity and physical stability due to hard polymers, thereby easily obtaining a renewable electrode surface through a simple polishing process, whenever the electrodes are inactivated and contaminated.

However, metal oxide polymer composite pH electrodes have problems in that, although the electrodes have excellent physical stability and surface renewability compared to conventional glass electrodes or polymer film electrodes, the manufacturing method of the electrode is complicated, the pH dependency of the electrodes varies greatly depending on the electrodes, and hysteresis occurs during repeated use of the electrodes. Moreover, the metal oxide polymer composite pH electrodes have a problem in that surface sensing materials can be ground and lost due to low hardness of the polymeric medium at the time of surface polishing for surface regeneration.

### SUMMARY OF THE INVENTION

Accordingly, the present invention has been made to overcome the above problems occurring in the prior art, and an object of the present invention is to provide a surface-polishable iridium oxide composite hydrogen ion electrode which has high durability and surface renewability.

Another object of the present invention is to provide a formed on the electrodes are anhydrous iridium oxides, and exhibit a responsivity of about 59 mV/pH unit according to Equation 2 or 3 below. It is disclosed in the document (P. VanHoudt, Z. Lewandowski, B. Little, Biotech. Bioeng. 1992, 40, 601-608).

IrO₂+H⁺+e⁻⇄IrO.OH [Equation 2]

or

2IrO₂+2H⁺+2e⁻⇄Ir₂O₃+H₂O [Equation 3]

Recently, novel hydrogen ion electrodes having hydrogen ion sensitivity, durability and surface renewability were developed by combining the characteristics of above iridium oxide film hydrogen ion electrodes, having durability and hydrogen ion concentration dependency, with technologies for manufacturing polymer composite electrodes (H. Quan, W. Kim, K.-C. Chung, J. Park, Bull. Korean Chem. Soc. 2005, 26, 1565-1568).

The iridium polymer composite hydrogen ion electrodes have an advantage in that the medium thereof is composed of polymer materials and carbon black particles or graphite particles, which are conductors, and uniformly includes iridium oxide particles, exhibiting selective sensitivity to hydrogen ion, so that the electrodes have hydrogen ion method of manufacturing a surface-polishable iridium oxide composite hydrogen ion electrode which has high durability and surface renewability.

In order to accomplish the above objects, an aspect of the present invention provides a surface-polishable iridium oxide composite hydrogen ion electrode, which has a long life due to its excellent physical strength, has pH dependency approximate to a theoretical value (59 mV/pH unit), and maintains high surface renewability, which is an advantage of a metal oxide polymer composite pH electrode.

Another aspect of the present invention provides a method of manufacturing a surface-polishable iridium oxide composite hydrogen ion electrode, including a first step of forming an inactive conductive material on a surface of high-temperature sinterable glass fine powder, ceramic powder or ceramic precursor powder; a second step of preparing high-temperature sinterable glass fine powder, ceramic powder or ceramic precursor powder, including metal/iridium oxides or iridium oxides alone, by dispersing the high-temperature sinterable glass fine powder, ceramic powder or ceramic precursor powder, coating on the surface thereof with the inactive conductive material formed in the first step or high-temperature sinterable glass fine powder, ceramic powder or ceramic precursor powder in a solution of iridium containing compound, evaporating and drying the solvent in the solution and thus applying the iridium compound on the surface of glass fine powder, ceramic powder or ceramic precursor powder, and then pyrolyzing compounds at below the sintering temperature; and a third step of molding the high-temperature sinterable glass fine powder, ceramic powder or ceramic precursor powder including metal/iridium oxides or iridium oxides alone and then high-temperature sintering or high-temperature high-pressure sintering the molded glass fine powder, ceramic powder or ceramic precursor powder.

In the first step, the inactive conductive material is selected from the group consisting of platinum (Pt), iridium (Ir), palladium (Pd), and gold (Au).

Further, in the first step, the inactive conductive material is formed using a reductive pyrolysis method, a simple mixing method, or an electroless plating method.

In the second step, it is preferred that the pyrolysis temperature of the applied compounds be in the range of 200 to 700° C.

Further, in the third step, the glass fine powder, ceramic powder or material powder, further including a binder, may be pressure-molded. In this case, preferably, the binder may be a polymer wax binder, but is not limited thereto.

Further, in the third step, preferably, the sintering temperature is in the range of 400 to 1,000° C., and more preferably 600 to 800° C. It is preferred that the sintering time be in the range of 3 to 5 hours.

Specifically, the first step is a step of being performed to maintain suitable electroconductivity of the iridium oxide composite hydrogen ion electrode material prepared through the present invention. The first step can be omitted when iridium oxide, which is a sensing material, is used alone, because the electroconductivity of the iridium oxide composite hydrogen ion electrode material, which is the final product, can be maintained with only iridium oxide.

In the first step, iridium compounds are dissolved in water, an organic solvent, or a mixture thereof. The organic solvent is not particularly limited, as long as it can dissolve iridium compounds.

Further, in order to improve the solubility of the iridium compound, an appropriate amount of acid may be added, or the components of the organic solvent may be changed.

The second step is a step of forming iridium oxides on the surface of the glass fine particles, ceramic particles or ceramic precursor powder. In the second step, iridium compounds are applied on the surface of high-temperature sinterable glass fine powder, ceramic particles or ceramic precursor powder having a size of 45 μm or less, or on the surface of the high-temperature sinterable glass fine powder, ceramic particles or ceramic precursor powder containing iridium metal particles, which is an inactive conductive material prepared in the first step, and the iridium oxides applied thereon are pyrolyzed in an oxygen or air atmosphere, thereby preparing glass fine powder, ceramic particles or ceramic precursor powder coated with the iridium oxide (IrO₂).

The third step is a step of preparing electrode materials. In the third step, the high-temperature sinterable conductive mixture of iridium oxide/glass fine powder, iridium oxide/ceramic particles or iridium oxide/ceramic precursor powder prepared in the second step, or a mixture of iridium metal/iridium oxide/glass fine powder, iridium metal/iridium oxide/ceramic particles or iridium metal/iridium oxide/ceramic precursor powder is molded or is molded while mixing a binder, and then the molded mixture is sintered at a temperature of 400 to 1,000° C. for 3 to 5 hours, thereby preparing an iridium oxide/glass or iridium oxide/ceramic composite electrode material or an iridium/iridium oxide/glass or iridium/iridium oxide/ceramic composite electrode material.

### BRIEF DESCRIPTION OF THE DRAWINGS

The above and other objects, features and advantages of the present invention will be more clearly understood from the following detailed description, taken in conjunction with the accompanying drawings, in which:

FIG. 1 is a graph showing the voltage change of an iridium oxide composite electrode of the present invention to pH change (reference electrode: Ag/AgCl);

FIG. 2 is a graph showing the electrode voltage dependency of an iridium oxide composite electrode of the present invention to pH change;

FIG. 3 is a graph showing the response time of an iridium oxide composite electrode of the present invention to pH change;

FIG. 4 is a graph showing the hydrogen ion sensing slope depending on the polishing of the surface of an iridium oxide composite electrode of the present invention;

FIG. 5 is a graph showing the long-term stability of an iridium oxide composite electrode of the present invention in various storage conditions; and

FIG. 6 is a graph showing the voltage stability of an iridium oxide composite electrode of the present invention.

### DESCRIPTION OF THE PREFERRED EMBODIMENTS

Hereinafter, the present invention will be described in detail with reference to Examples.

Here, these Examples are set forth to illustrate the present invention, but should not be construed as the limit of the present invention.

### EXAMPLE 1

### Formation of Inactive Conductive Material

0.5 g of (NH₄)₂IrCl₆ was put in a 200 ml round bottomed flask, and was then dissolved in water by adding 50 ml of water to the flask. Subsequently, 5 ml of ethanol was additionally added to the solution in order to improve the solubility thereof.

Subsequently, 1.7 g of glass fine powder, having a particle size of 45 μm or less, was added to the flask, and the flask, to which the glass fine powder was added, was installed in a rotary evaporator, and then the solvent present in the flask was evaporated and dried at a temperature of 80° C., thereby coating the glass fine powder with (NH₄)₂IrCl₆.

Subsequently, the glass powder, coated with (NH₄)₂IrCl₆, was charged in a boat type crucible, and the crucible, containing the glass powder coated with the (NH₄)₂IrCl₆, was installed in a tubular furnace, and then the crucible was heated to a temperature of 500° C. for 5 hours in a hydrogen atmosphere, and thus the (NH₄)₂IrCl₆ applied on the surface of the glass powder was decomposed and reduced, thereby forming fine iridium metal particles on the surface of glass.

### EXAMPLE 2

### Formation of Iridium Oxde

0.5 g of (NH₄)₂IrCl₆ was put in a 200 ml flask with a round bottom, and was then dissolved in water by adding 50 ml of water to the flask. Subsequently, 5 ml of ethanol was additionally added to the solution in order to improve the solubility thereof.

Subsequently, 1.7 g of glass fine powder having a particle size of 45 μm or less, or glass fine powder including iridium metal fine particles formed in Example 1, was added to the flask, and the flask, to which the glass fine powder was added, was installed in a rotary evaporator, and then the solvent present in the flask was evaporated and dried at a temperature of 80° C., thereby coating the glass fine powder with (NH₄)₂IrCl₆.

Subsequently, the glass powder, coated with (NH₄)₂IrCl₆, was charged in a boat type crucible, and the crucible, containing the glass powder coated with the (NH₄)₂IrCl₆, was installed in a tubular furnace, and then the crucible was heated to a temperature of 500° C. for 5 hours in an air or oxygen atmosphere, and thus the (NH₄)₂IrCl₆ applied on the surface of the glass powder was oxidized to iridium oxide, thereby forming a high-temperature sinterable mixture of iridium oxide/glass fine powder or iridium metal/iridium oxide/glass fine powder.

### EXAMPLE 3

### Preparation of Composite Electrode Material

The high-temperature sinterable mixture of iridium oxide/glass fine powder or iridium metal/iridium oxide/glass fine powder, formed in Example 2, was molded, and then the molded mixture was sintered at a temperature of 700° C. for 4 hours, thereby preparing a polishable iridium oxide/glass composite electrode material or a polishable iridium metal/iridium oxide/glass composite electrode material.

### EXAMPLE 4

### Evaluation of Sensitivity of Electrode

The sensitivity of the iridium oxide/glass composite hydrogen ion electrode prepared in Example 3 was measured.

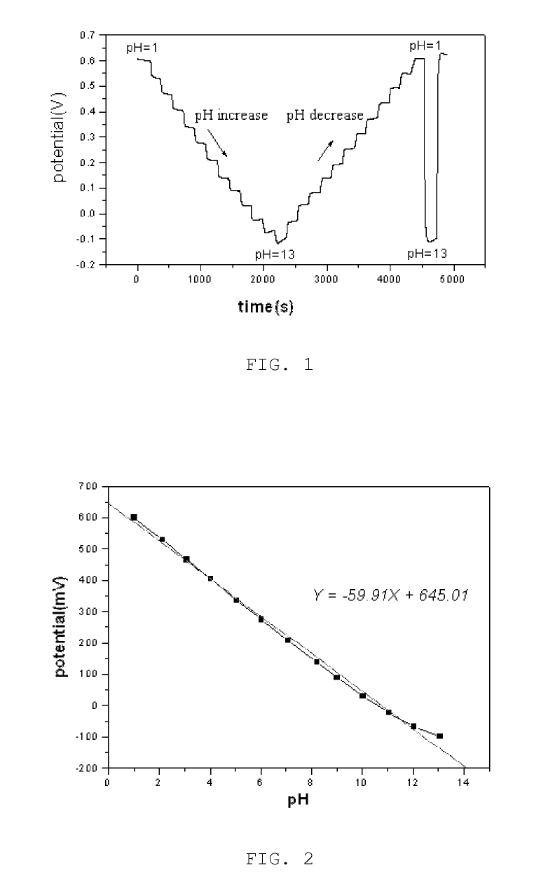

A pH glass electrode and the iridium oxide/glass composite hydrogen ion electrode were immersed into 0.1 M of a universal buffer solution including phosphoric acid, boron acid, acetic acid and potassium chloride, and the pH of the solution was set to 1. Subsequently, the potentials of the iridium oxide/glass composite hydrogen ion electrode vs. Ag/AgCl (3.0 M KCl) electrode were measured while changing the pH of the solution in the range of 1 to 13 by adding potassium hydroxide and nitric acid to the solution, and the results thereof are shown in FIG. 1.

In this case, the pH of the solution was increased stepwise to 13, and was then decreased to 1 by adding nitric acid to the solution.

As shown in FIG. 1, it can be seen that the potentials of the electrode stabilized at new potentials rapidly depending on the change in the pH of the solution.

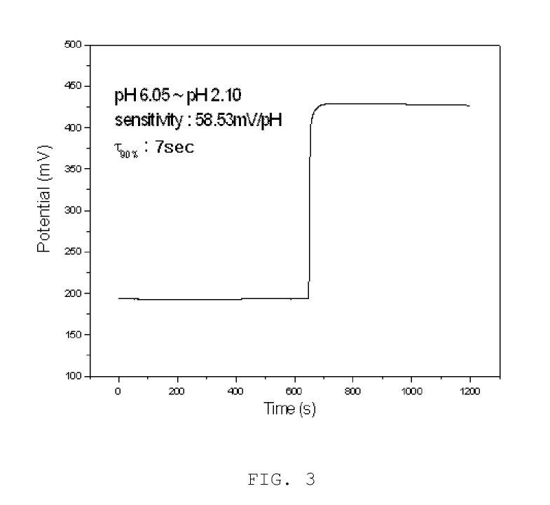

Meanwhile, the potential of the electrode depending on the pH of the solution is shown in FIG. 2.

As shown in FIG. 2, it can be seen that the iridium oxide composite hydrogen ion electrode of the present invention exhibits a slope of 59.9 mV/pH unit, and the slope approximates to a theoretical value of 59.2 mV/pH unit.

### EXAMPLE 5

### Evaluation of Responsivity of Electrode

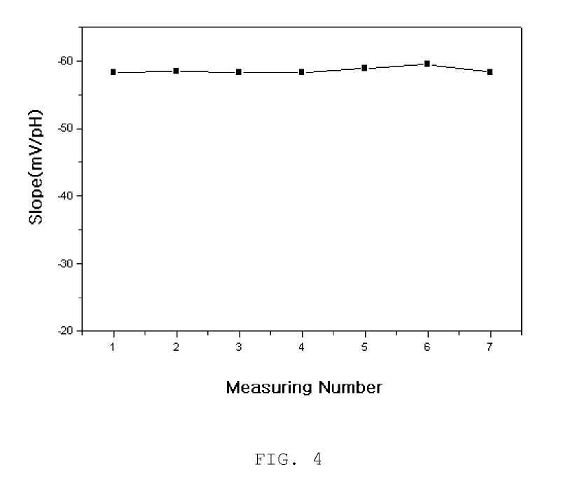

In order to evaluate the response time of the iridium oxide/glass composite hydrogen ion electrode prepared in Example 3, the time that it takes for the potential of the electrode to reach 90% of the final potential of the electrode, was measured while the pH of the solution was changed, and the results thereof were shown in FIG. 3.

As shown in FIG.3, it can be seen that, when the pH of the solution was changed from 6.05 to 2.10, the time T₉₀ that it took for the potential of the electrode to reach 90% of the final potential was 7 seconds or less, and thus the electrode exhibits high responsivity.

### EXAMPLE 6

### Evaluation of Surface Renewability of Electrode

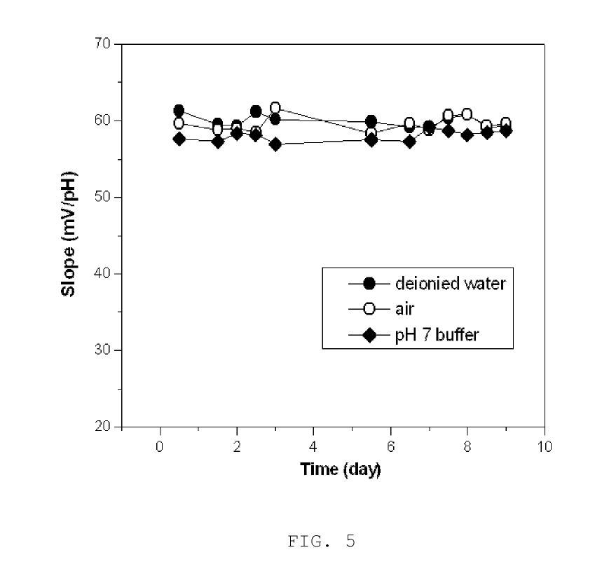

The surface of the electrode (containing 13% of iridium oxide) prepared in Example 3 was finely polished using a 2000 grit SiC paper, and then the potential of the electrode was measured in solutions of pH 4, 7, and 10. The response slope was evaluated for seven trials. Between each set of measurements the surface of the electrode was re-polished completely. Thereafter, the pH sensitivity of the electrode was measured in each case (referring to FIG. 4).

As shown in FIG. 4, it can be seen that the average response of the pH sensitivity of the electrode is −58.6 mV/pH unit, and the relative standard deviation (rsd) thereof is 0.76%, which is excellent.

### EXAMPLE 7

### Evaluation of Stability of Electrode

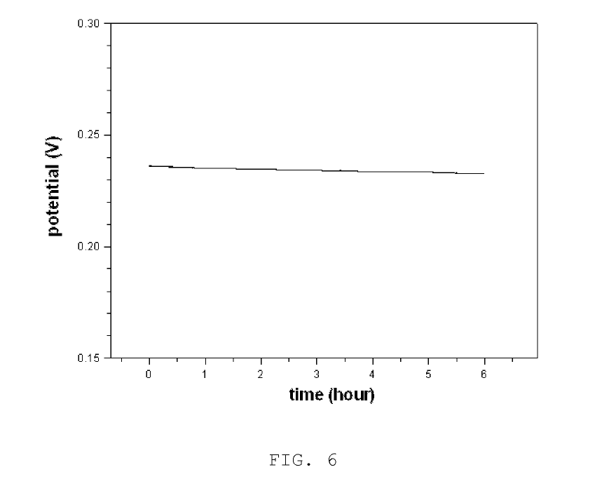

FIGS. 5 and 6 show the changes in the responsivity of iridium oxide composite pH electrode depending on the length of the period of use thereof.

FIG. 5 shows the response slope of the electrode to hydrogen ion concentration when the solution is neutral (pH 7), that is, when the electrode is left in air or is stored in distilled water or a neutral buffer solution for a long time.

In FIG. 5, it can be seen that the deviation in the responsivity of the electrode was 1 mV/pH unit, which is very small.

In FIG. 6, it can be seen that 3 mV of electrode voltage drift is exhibited as the result of measuring electrode voltage for 6 hours.

As described above, an iridium oxide composite electrode according to the present invention is effective in that the electrode has very high physical strength because it has a glass or ceramic medium, unlike conventional electrodes, and, when the electrode is contaminated or inactivated, the surface of the electrode can be regenerated through a simple polishing process because iridium oxide, which is a sensing material, is uniformly included in the entire electrode medium.

Accordingly, the iridium oxide composite electrode according to the present invention can be usefully used in a water-quality monitoring system for monitoring the hydrogen ion concentration of a solution for a long period, an online measurement system, and pH measurement for samples causing serious contamination on the surface of sensor.

What is claimed is:

1. A method of manufacturing a surface-polishable iridium oxide composite hydrogen ion electrode, comprising:
a first step of forming an inactive conductive material on a surface of high-temperature sinterable glass fine powder, ceramic powder or ceramic precursor powder;
a second step of preparing high-temperature sinterable glass fine powder, ceramic powder or ceramic precursor powder, including metal/iridium oxides or iridium oxides alone, by dispersing the high-temperature sinterable glass fine powder, ceramic powder or ceramic precursor powder coated on the surface thereof with the inactive conductive material formed in the first step or high-temperature sinterable glass fine powder, ceramic powder or ceramic precursor powder in an iridium and metal containing compound solution, evaporating and drying a solvent from the solution, thus applying the iridium compound on the surface of glass fine powder, ceramic powder or ceramic precursor powder, and then pyrolyzing compounds applied at below the sintering temperature; and
a third step of molding the high-temperature sinterable glass fine powder, ceramic powder or ceramic precursor powder, including metal/iridium oxides or iridium oxides alone, and then high-temperature sintering or high-temperature high-pressure sintering the molded glass fine powder, ceramic powder or ceramic precursor powder.

2. The method according to claim 1, wherein the inactive conductive material in the first step is selected from the group consisting of platinum (Pt), iridium (Ir), palladium (Pd), and gold (Au).

3. The method according to claim 1, wherein, in the first step, the inactive conductive material is formed using a pyrolysis reduction method, a simple mixing method, or an electroless plating method.

4. The method according to claim 1, wherein the pyrolysis temperature of the applied compounds is in the range of 200 to 700° C.

5. The method according to claim 1, wherein, in the third step, the glass fine powder, ceramic powder or ceramic precursor powder, further including a binder, is molded.

6. The method according to claim 1, wherein, in the third step, the sintering temperature is in the range of 400 to 1,000° C.

7. A surface-polishable iridium oxide composite hydrogen ion electrode manufactured using the method according to claim 1.
